(19) United States
(12) Patent Application Publication
(10) Pub. No.: US 2010/0056720 A1
(43) Pub. Date: Mar. 4, 2010

(54) SELF-ASSEMBLING METHOD AND STRUCTURE

(75) Inventors: Sunghoon Kwon, Seoul (KR); Sueun Chung, Seoul (KR)

Correspondence Address: SUNGHOON KWON, FACULTY APT. 122I-104, SAN 4-2, BONGCHUN 7 DONG, GWANAK-GU, SEOUL, KR

(73) Assignee: Seoul National University Industry Foundation

(21) Appl. No.: 12/199,351

(22) Filed: Aug. 27, 2008

(51) Int. Cl. C08L 89/00; C08F 291/00

(52) U.S. Cl. 525/54.1; 525/50; 525/54.2

(57) ABSTRACT

Disclosed are compositions and methods for self-assembling polymeric particles by using biological binders attached to subunits of a multi-sectioned polymeric particle.

### BACKGROUND

Self-assembly is the spontaneous and reversible organization of molecular units into ordered structures by non-covalent interactions. Through the non-covalent interactions more than two molecular units can be assembled to form polymer structures. In particular, self-assembled polymer structures are useful in many industrial applications, for example, in biological systems, such as the formation of double-helical DNA or the combination of proteins for quaternary structures.

Although there are certain advantageous uses for self-assembled polymer structures, current materials and methods have difficulties in producing structures of high complexity. For example, the exquisite specificity of Watson-Crick base paring allows a combinatorially large set of nucleotide sequences to be used when designing binding interactions. The field of DNA technology has exploited this property to create a number of more complex nanostructures. Because the synthesis of such nanostructures involves interactions between a large number of short oligonucleotides, the yield of complete structures is highly sensitive to stoichiometry (the relative ratios of strands). The synthesis of relatively complex structures was thus thought to require multiple reaction and purification steps, with the ultimate complexity of DNA nanostructures limited by necessarily low yields. Thus, current materials and method for producing self-assembling structures contain Just a few unique positions that may be addressed as pixels. Therefore, there is a need to easily create self-assembling, highly complex structures with desired sizes and properties.

### SUMMARY

Described herein are materials and methods related to the unexpected discovery that complementary nucleic acids can be used to drive self-assembly of polymers into higher order structures with desired shape and size without complicated processing steps. This can be achieved by one or more methods of self-assembling polymers. The methods comprise attaching one or more biological binders to one or more multi-sectioned polymers, under conditions where a first biological binder attached to a first multi-sectioned polymer binds to a second biological binder attached to a second multi-sectioned polymer partner, thereby achieving self-assembly of the polymers.

In some aspects, the biological binder is a macromolecule that hybridizes to a complementary macromolecule or that forms a protein-protein interaction with a macromolecule partner. In some aspects, the first and second multi-sectioned polymers are formed by a method comprising: forming a laminar flow in a microfluidic system comprising a plurality of microfluidic channels, wherein at least one channel comprises a solution comprising one or more oligomers, so that a plurality of sections can be formed between the oligomer solutions; and polymerizing the plurality of the oligomer solutions to form the first and second multi-sectioned polymers, thereby forming the first and second multi-sectioned polymers. In some aspects, the plurality of oligomers is polymerized by illuminating a light source. The light source comprises ultraviolet light. In some aspects, the method of forming the first and second multi-sectioned polymers further comprises: controlling compositions of the plurality of oligomer solutions provided to the plurality of microfluidic channels to achieve a desired multi-section configuration of each of the first and second multi-sectioned polymers. In some aspects, the compositions of the plurality of oligomer solutions are controlled such that at least one first oligomer solution is different from at least one second oligomer solution.

In some aspects, one or more biological binders are attached to each of the multi-sectioned polymers by contacting the one or more biological binders to at least one chemically-treated nanoparticle. The one or more biological binders are contained in a solution in a microfluidic channel, and the chemically-treated nanoparticle combines the one or more biological binders to the one or more multi-sectioned polymers, under conditions such that the one or more nanoparticle contacted biological binders are attached to at least one section of each of the first and second multi-sectioned polymers. In some aspects, the nanoparticles are chemically treated with a chemical compound comprising thiol function group.

In some aspects, the biological binders are selected from the group consisting of: DNA, RNA, PNA, artificial nucleic acids, artificial polypeptides and protein. In some aspects, two or more biological binders are attached individually to two or more sections of one or more multi-sectioned polymers. In some aspects, the method of self-assembling polymers further comprises repeating assembling of the polymers to form a web structure of self-assembled polymers.

In some aspects, one or more self-assembled polymer structures are formed using the methods of self-assembling polymers described herein. In some aspects, one or more biosensors comprise the self-assembled polymer structures formed using the methods of self-assembling polymers described herein.

In some aspects, one or more self-assembled polymer structures comprise: a plurality of multi-sectioned polymers; and one or more biological binders attached to each of the multi-sectioned polymers. Each binder can bind to a complementary partner biological binder. The multi-sectioned polymers are assembled using the complementary sequences of the one or more biological binders attached to each of the polymers.

In some aspects, the one or more biological binders are attached to at least one section of each of the multi-sectioned polymers. In some aspects, each of the multi-sectioned polymers is chemically treated. In some aspects, the polymers are chemically treated with a composition comprising a thiol function group. In some aspects, the biological binders are selected from the group consisting of: DNA, RNA, PNA, artificial nucleic acids, artificial polypeptides and protein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a view illustrating an illustrative embodiment of a continuous flow lithography system to form multi-sectioned polymeric particles.

FIG. 1B is a view schematically illustrating an embodiment of binding complementary DNA sequences to each section of the multi-sectioned polymeric particles of FIG. 1A.

FIGS. 2A and 2B are views of illustrative embodiments of complementary DNA sequences provided to a first stream and a second stream of the microfluidic channel system illustrated in FIG. 1B.

FIGS. 2C and 2D are views of illustrative embodiments of complementary DNA sequences provided to a third stream and a fourth stream of the microfluidic channel system illustrated in FIG. 1B.

FIG. 3 is a view of an illustrative embodiment of a self-assembled structure of a plurality of polymeric particles with complementary DNA sequences.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. In accordance with some aspects, self-assembled structures with desired physical and chemical properties are provided. As used herein, the “self-assembled structure” refers to any arrangement that can be formed by binding of at least one biological binder to a partner. In one embodiment, the self-assembled structures are formed, for example, by using biological binders having complementary portions, such as, for example, naturally-occurring and synthetic nucleic acids or proteins. The biological binders can include, but are not limited to, biological macromolecules, such as, DNA, RNA, PNA and other non-naturally occurring nucleic acids, protein etc. As used herein a “macromolecule” refers to a large molecule, which, in the context of biochemistry, can refer to the four conventional biopolymers (nucleotides, proteins, carbohydrates, and lipids), as well as non-polymeric molecules with large molecular mass such as macrocyctes. Although not listed here, all macromolecules that are capable of hybridizing to a complementary sequence or proteins capable of binding to a binding partner can be used as the biological binders,

In some embodiments, the biological binders can be attached to subunits of multi-sectioned polymers such that, when the biological partners hybridize or bind to their complementary sequences, a self-assembled structure is formed. As used herein, “polymer” refers to a macromolecule composed of repeating subunits connected by covalent chemical bonds. As used herein “subunit” refers a molecular component of a macromolecule such that the macromolecule comprises multiple subunits. Each subunit or groups of subunits, e.g., oligomers, correspond to each section of the multi-sections of the polymer. Polymers can be formed, for example, by polymerizing an oligomer. A photocurable oligomer flowing through a microfluidic channel of a microfluidic system can be illuminated with a light source, for example, ultraviolet light. As used herein, the term “oligomer” refers to a group of subunits, e.g., short single-stranded DNA fragments, generally used in hybridization experiments, short polypeptides, etc. Oligomers can refer to a protein complex made of two or more subunits. A complex made of several different protein subunits is called a hetero-oligomer. Where only one type of protein subunit is used in the complex, it is called homo-oligomer.

As used herein “microfluidic system” refers to a system for manipulation of fluid and has any type of microfabricated channel in which fluids flow at a microscale. The microfluidic system can include, but is not limited to, a continuous flow microfluidics and digital microfluidics. Continuous flow microfluidics is based on the manipulation of continuous liquid flow through microfabricated channels. Digital microfluidics is droplet-based microfluidics where discrete, independently-controllable droplets are manipulated on a substrate.

In some embodiments, the binding between binding partners can be hybridization between complementary sequences if the biological binders are DNA, RNA, PNA or any other non-naturally occurring nucleic acids. In another embodiment, the binding can be protein-protein interactions if the biological binders are proteins. Proteins are large organic compounds made of amino acid subunits arranged in a chain and Joined together by peptide bonds. A protein has an amino acid sequence that is specified by a nucleotide sequence of the coding sequence of a gene encoding the protein. As proteins often have activity when bound to other proteins, they have sequence domains, “motifs”, that are capable of interacting and binding to other proteins via protein-protein interactions. These interactions allow proteins to be used as biological binders.

In some embodiments, the multi-sectioned polymers can be formed by a continuous flow lithography system. As used herein the “continuous flow” refers to a microfluidic channel system. A continuous flow system can be used in conjunction with other techniques and systems, for example, a microscope projection lithography technique. In some embodiments, the multi-sectioned polymers can be prepared by positioning a microfluidic channel on a microscope, illuminating light from a lamp attached to the microscope onto the microfluidic channel, thereby causing polymerization of oligomers where laminar flow is generated in the microfluidic channel while flowing the oligomers in the microfluidic channel. As used herein the “laminar flow” refers to streamline flow, which occurs when a fluid flows in parallel layers, with no disruption between the layers. The lamp attached to the microscope can be, for example, a UV light. In response to the UV light illuminated to the microfluidic channel, the multi-sectioned polymers can be formed. Although the continuous flow lithography system is used to form the polymers in some embodiments, the present disclosure is not limited to this continuous flow lithography system. Thus, the multi-sectioned polymers, each having interfaces between respective sections, are formed using, for example, multiple microfluidic streams.

In some embodiments, the subunits of the polymer can be polymerized from the same oligomer or different oligomers. For example, if the solutions having the same oligomers are provided in the microfluidic channels while forming laminar flow in the channels, the multi-sections of the polymer will have the same composition. Alternatively, if the solutions having different oligomers are provided into each microfluidic channel while forming the laminar flows in the channels, the multi-sections of the polymer will have different compositions. Alternatively, if the different oligomer solutions can be provided into some of the microfluidic channels while forming the laminar flows in the channels, some of the multi-sections of the polymer will have different compositions and some of the multi-sections of the polymer will have the same composition. Thus, the compositions of the oligomer solutions provided into the channel can be controlled such that the multi-sections of the polymer are different from each other.

In some embodiments, the multi-sectioned polymers can be chemically treated to facilitate attachment to the biological binders. The “attachment” can be, for example, a covalent binding between the biological binders and the polymers, but the present disclosure is not limited thereto. A streptavidin-biotin non-covalent attachment, for example, can be used to attach the multi-sectioned polymers and the biological binders, but the present disclosure is not limited to the streptavidin-biotin linkage. Any linkage that can attach the biological binders to the polymers can be used in the present disclosure. In some embodiments, the polymers can be chemically treated before polymerization. For example, the polymers can be formed in a solution having chemically-treated nanoparticles.

As used herein, the “nanoparticle” refers a particle defined as a small object that behaves as a whole unit in terms of its transport and properties. It generally has a size of about between 100 and 2500 nanometers. In one embodiment, the nanoparticle can include, but is not limited to, one or more gold or silver atoms. The nanoparticle can be treated with a chemical compound having a thiol function group, for example, streptavidin. The streptavidin-treated nanoparticle can be provided into the solution containing the oligomers. Thus, in response to the light illuminated to the microfluidic channel, the streptavidin-treated nanoparticles can be coated on a surface of the polymers during the polymerization of the oligomers. Because the biological binders can be provided into the solution along with biotin, the biological binders can attach to the multi-sectioned polymers through the streptavidin-biotin interaction.

In some embodiments, the multi-sectioned polymers can be self-assembled using the complementary portions of the biological binders bound to the polymer partners. A first multi-sectioned polymer having a first biological binder, such as, for example, DNA, RNA or PNA and a second multi-sectioned polymer having a second biological binder having a complementary portion of the first biological binder, will interact with each other to self-assemble into a higher-order structure. The first and second multi-sectioned polymers can self-assemble by hybridization of the first and second biological binders.

In addition to the use of hybridization and base-pairing to allow for self-assembly of higher-order structures, the first and second biological binders can be, for example, peptides (e.g., naturally-occurring or artificial), wherein the first and second multi-sectioned polymers can be self-assembled by utilizing protein-protein interactions of the first and second biological binders. In still another embodiment, if the first and second biological binders each are protein, the first and second multi-sectioned polymers can be self-assembled by using protein-protein interaction of the first and second biological binders.

In some embodiments, self-assembly be used in a “bottom-up” approach used in nanotechnology. As used herein, the “bottom-up” approach refers to essentially piecing together systems to give rise to grander systems, thus making the original systems sub-systems of the emergent system. In the bottom-up approach the individual base elements of the system are first specified in great detail. These elements are then linked together to form larger subsystems, which then in turn are linked. In some embodiments, individual base elements of subunits are polymerized in a microfluidic channel to form larger subsystem of polymers, and then the biological macromolecules being attached to each subunit of the polymers combine complementarity with each other to form self-assembled structure.

A bottom-up approach is a concept opposed to a “top-down” approach, and can be utilized to develop, for example, microchips. DNA nanotechnology can use bottom-up self-assembling approaches to create self-assembling branched DNA complexes by using unique molecular recognition properties of DNA and other nucleic acids.

In some embodiment, a web structure of self-assembled polymeric particles can be formed by repeating the self-assembling process in which multi-sectioned polymeric particles are bound to each other, for example, by the complementary binding between the complementary DNA sequences attached to subunits of the polymers.

In some embodiments, a plurality of polymers each having odd-numbered sections, can be formed according to the methods described herein. A biological binder then can be bound to each section of the polymers. Then the polymers can be arranged from an upper direction to a lower direction in parallel with respect to the middle sections of these particles, such that the number of sections of the polymers can be increased from the upper direction to the lower direction. The parallel and adjacent sections of the polymers then can be bound by using the complementary sequences attached on the sections. As a result, a web structure of self-assembled polymers can be construed. A composition having the web structure can be used in various technical fields, such s, for example, use as a biosensor, an integrated circuit, DNA sequencing, etc.

In some embodiment, a biosensor, e.g., an evanescent wave biosensor, an acoustic wave biosensor, an optical fiber DNA biosensor, or an electrochemistry biosensor, can be construed with the self-assembling methods and structures described herein. An evanescent wave biosensor and an acoustic wave biosensor can detect a change in physical properties generated at a surface between a sample and a detector. Thus, these biosensors can indirectly detect DNA hybridization. An optical fiber DNA biosensor can use glass thread to perform optical signaling in response to a total internal reflection from probe-target hybridization to a detector. An electrochemistry biosensor can detect a change in current or resistance generated due to target-DNA hybridization by using DNA probe molecules attached to an electrically activated surface.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure,

The present embodiments, thus generally described, will be understood more readily by reference to tie following examples, which are provided by way of illustration and are not intended to be limiting of the present technology in any way.

### EXAMPLES

### Example 1

### A Continuous Flow Lithography System for Preparing a Multi-Sectioned Polymer

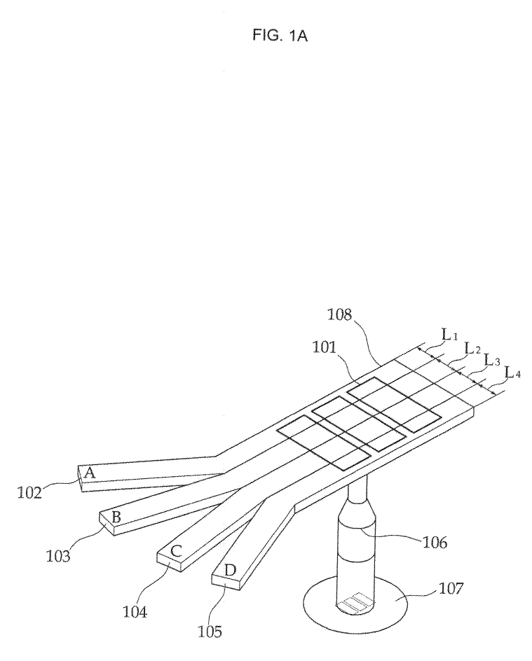

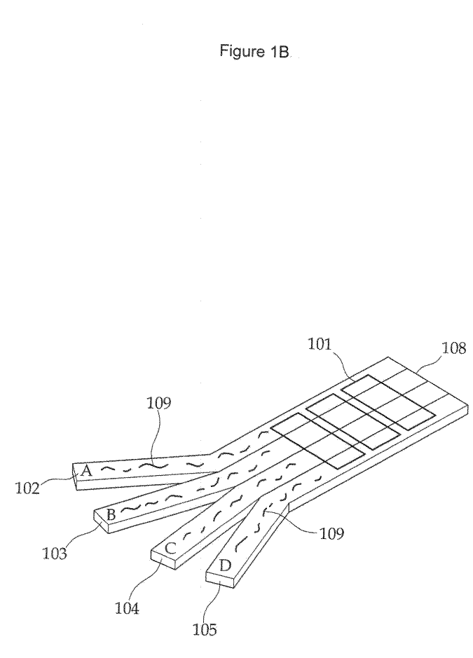

FIG. 1A illustrates a continuous flow lithography system for preparing a multi-sectioned polymer in accordance with one embodiment. As illustrated in FIG. 1A, a microfluidic channel system 108 includes four streams, that is, a first stream 102, a second stream 103, a third stream 104, and a forth stream 105. The microfluidic channel system 108 is positioned over a microscope 106, and a mercury lamp 107 is attached to the microscope 106. The microfluidic channel system 108 is adapted to allow a first oligomer solution(A) of the first stream 102, a second oligomer solution(B) of the second stream 103, a third oligomer solution(C) of the third stream 104, and a forth oligomer solution(D) of the forth stream 105, to continuously flow. The shape of the microfluidic channel system 108 can vary according to the desired number and size of sections of a polymeric particle.

While these four oligomer solutions (A, B, C, and D) flow through the microfluidic channel system 108 forming four streams of the first stream 102, the second stream 103, the third stream 104, and the forth stream 105, the four oligomer solutions forming four streams are illuminated by, for example, UV light emitted from the lamp 107 attached to the microscope 106. In response to the light source, the four oligomer solutions forming four streams are continuously polymerized into a polymer 101 having four sections, while the four oligomer solutions flow through the microfluidic channel system 108. To adjust the polymerization of such the polymer 101, the stream widths L1, L2, L3 and L4 of the four streams flowing through the microfluidic channel system 108 can be changed by adjusting the flow rates of these four streams.

Since a laminar flow is formed in the microfluidic channel system 108, the first stream 102, the second stream 103, the third stream 104, and the forth stream 105 of the oligomer solutions can flow in parallel through the microfluidic channel system 108 without interference with each other. As a result of this, a four phase flow can be formed in the microfluidic channel system 108.

The four-sectioned polymeric particle 101 can have a non-spherical shape. In some embodiments, the ratio of each section in the polymer 101 can be diversely adjusted by the stream widths L1, L2, L3, and L4 of the first stream 102, the second stream 103, the third stream 104, and the forth stream 105, respectively, as described in FIG. 1A.

Since the four streams of four oligomer solutions are alternately disposed, the polymer 101 has three interfaces (between 102 and 103, between 103 and 104, and between 104 and 105). Thus, a four-sectioned polymer 101 having three interfaces is formed from four kinds of oligomer solutions. In some embodiments, the four oligomer solutions may be of the same kind or of different kinds. In some embodiments, some of the four oligomer solutions can be of the same kind or of different kinds. Among the four oligomer solutions (A, B, C and D), for example, the oligomer solutions (A and B) of the first stream 102 and the third stream 104 have the same composition, and the oligomer solutions (C and D) of the second stream 103 and the forth stream 105 have the same composition. Alternatively, the oligomer solutions (A, B, C and C) of the first stream 102 to the fourth stream 105 can be different from each other.

In some embodiments, the four oligomer solutions can be disposed in the microfluidic channel in such a manner that an oligomer solution is disposed alternately with an oligomer solution having a different composition, or oligomer solutions having the same composition are disposed adjacent to each other. The adjacent two streams, the first stream 102 and the third stream 104, as shown in FIG. 1A, for example, can have the same composition.

### Example 2

### Binding Biological Macromolecules to Polymers

In some embodiments, a multi-sectioned polymer can be formed to bind one or more biological binders to the polymer, as described later with reference to FIG. 1B. Although FIG, 1B is illustrated with the continuous flow lithography system having four microfluidic channels in which a four-sectioned polymer is formed, the method is not limited to the continuous flow lithography. Any method can be used to form a polymer having multi-sectioned as long as a polymer having more than one sections can be formed.

Further, in some embodiments, a polymer having a desired number of sections can be formed using a microfluidic channel system having as many channels as the desired number of sections of the polymeric particle, although a four-sectioned polymer is formed using a microfluidic channel system having four channels in FIG. 1A (Example 1).

Biological binders are bound, for example, to each section of the four-sectioned polymer 101.

FIG, 1B schematically illustrates binding between complementary sequences and each section of multi-sectioned polymer, which are prepared according to the process of FIG. 1A. Although not illustrated in FIG. 1B, there is a lamp 107 attached to a microscope 106 on which the microfluidic channel system 108 is positioned, as described above with reference to FIG. 1A.

In addition, as illustrated in FIG. 1B, biological binders 109 flow together through the streams of the four respective oligomer solutions A, B, C, D. The biological binders 109 include a material having a complementary sequence. The biological binders 109 flowing through the streams of the oligomer solutions can be, for example, DNAs having the same sequence or different sequences.

Where the biological binders 109 are DNAs having the same sequence, the same DNA sequence will be bound to each section of the polymer 101. Alternatively, where DNAs having different sequences flow through the respective streams, different DNA sequences will be bound to the respective sections of the polymer 101.

To bind the DNA biological binders to the multi-sectioned polymer, the polymer can be formed in a solution having nanoparticles. In some embodiments, a solution having chemically-treated nanoparticles can be provided to each oligomer solution in a corresponding stream in the microfluidic channel system 108. A UV light can be used to illuminate the microfluidic channel system 108 by using the lamp (107 in FIG. 1a) to polymerize the oligomer solutions. As a result, the polymer 101 having multi-sections is formed. In some embodiments, the chemically-treated nanoparticles include nanoparticles coated with a chemical compound, for example, streptavidin having a thiol functional group. Any chemical compound can be used to treat the nanoparticles as long as it has a thiol functional group. Thus, the polymer 101 formed in the solution, which includes the nanoparticle treated with the chemical compound having the thiol function group, will have the chemically-coated nanoparticle as one component.

The solution including one or more biological binders is then provided to the microfluidic channel system 108. The biological binders 109 bind to each section of the multi-sectioned polymer 101. In some embodiments, the biological binders 109 can be provided to the microfluidic channel system 108, along with biotin. Biotin, the binding properties of which are generally known to those of skill in the art, is used to combine the biological binders. Streptavidin, for example, can be attached to the biological binders, which are included in a solution having the biotin. As the biotin and the biological binders are together provided to the microfluidic channel system 108, the biological binders bind to the streptavidin attached to the nanoparticles, which is one component of the polymer. Accordingly, the biological binders can be bound to each of the sections of the polymer 101.

### Example 3

### Complementary Part of Biological Macromolecules

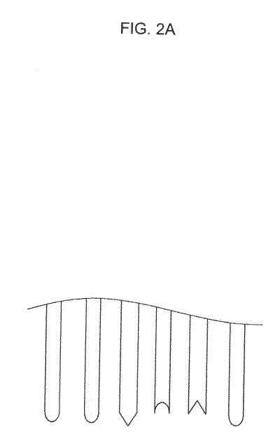

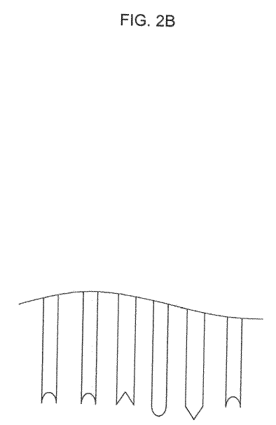

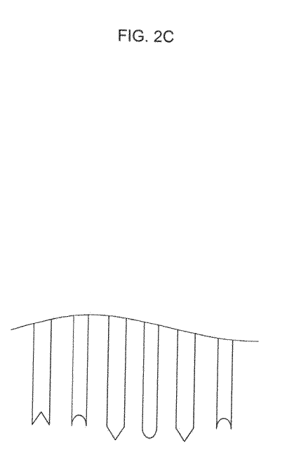

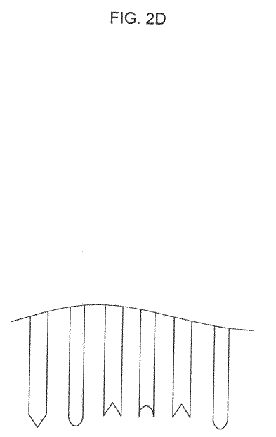

FIGS. 2A and 2B are views of complementary DNA sequences provided to a first stream and a second stream of the microfluidic channel system illustrated in FIG. 1B, respectively. In FIGS. 2A and 28, the DNA sequences provided to the first stream 102 are complementary to those provided to the second stream 103. FIGS. 2C and 2D are views of complementary DNA sequences provided to a third stream and a forth stream of the microfluidic channel system illustrated in FIG. 1B, respectively. In FIGS, 2C and 2D, the DNA sequences provided to the third stream 104 are complementary to those provided to the fourth stream 105.

### Example 4

### Self-Assembled Structure of a Plurality of Polymers

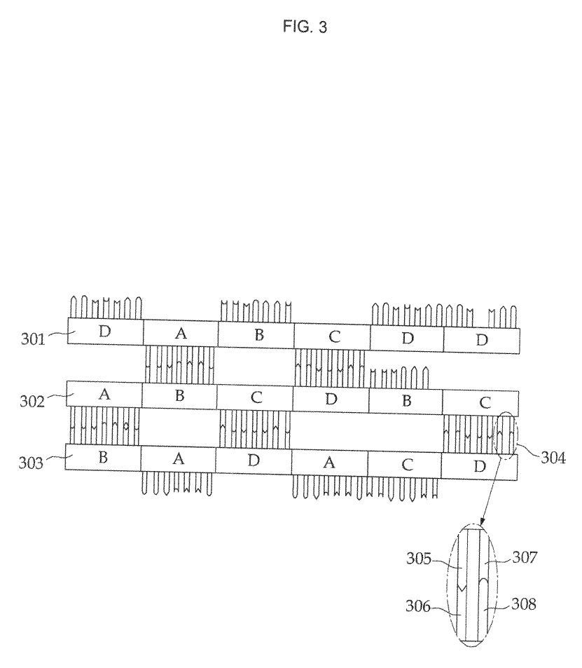

FIG. 3 illustrates a self-assembled structure of a plurality of polymers with complementary DNA sequences attached to the polymers, which are prepared according to the process of FIGS. 1A and 1B. In FIG. 3, three polymers 301, 302, 303, each having six sections, are illustrated. These polymers 301, 302, 303 are formed using a continuous flow lithography system, which is a microfluidic channel system combined with a microscope projection lithography technique, as described with reference to FIG. 1A. As described above, the method for preparing the polymers 301, 302, and 303 is not limited to the continuous flow lithography system.

In this embodiment, the microfluidic channel system having six channels is used. Also, the streams of oligomer solutions flowing through the microfluidic channel system are “DABCDD”, “ABCDBC”, and “BADACD”, for example. Such configurations of sections of the polymers are merely illustrative, and multi-sectioned polymers having various combinations of sections can be formed according to the number and arrangement of streams flowing through the microfluidic channel system.

The polymer 301 located uppermost in FIG. 3, for example, is a six-sectioned polymer formed using six streams D, A, B, C, D, D of an oligomer solution D, an oligomer solution A, an oligomer solution B, an oligomer solution C, the oligomer solution D, and the oligomer solution D. The polymer 302 located in the middle of FIG. 3 is a six-sectioned polymer formed using six streams A, B, C, D, B, C of the oligomer solution A, the oligomer solution B, the oligomer solution C, the oligomer solution D, the oligomer solution B, and the oligomer solution C, The polymer 303 located at the bottom of FIG. 3 is a six-sectioned polymer formed using six streams B, A, D, A, C, D of the oligomer solution B, the oligomer solution A, the oligomer solution D, the oligomer solution A, the oligomer solution C, and the oligomer solution D.

The multi-sectioned polymers 301,302, 303 have a structure in which different DNA sequences are formed on their respective section A, B, C, D, as illustrated in FIG. 3. In some embodiments, however, some sections can also have the same sequence. In FIG. 3, different DAN sequences 109 flowing through the microfluidic channel while being included in the respective streams 102, 103, 104, 105 are bound to the respective sections A, B, C, D corresponding to the respective streams 102, 103, 104, 105 in the process of preparing the multi-sectioned polymer 101 in FIG. 1A.

Where the DNA sequences bound to sections A and B are complementary, and the DNA sequences bound to sections C and D are complementary. Due to the complementary between the DNA sequences, the multi-sectioned polymers 301, 302, 303 self-assemble as illustrated in FIG. 3. Section A, for example, hybridizes to section B by complementarity, and section C hybridizes section D by complementarity. A reference numeral 304 indicates an enlarged portion of the complementary binding between sections C and D. A reference numeral 305 indicates a DNA base, an adenine, and a reference number 308 indicates a DNA base, thymine. Due to the complementarity between adenine and thymine, two DNA bases can hybridize. The DNA bases indicated by reference numerals 307 and 308, guanine and cytosine, similarly can hybridize.

The polymers 301, 302, 303 including these sections self-assemble by the complementary hybridization between sections A and B and the complementary hybridization of sections C and D, as illustrated in FIG. 3.

### Equivalents

The present disclosure is not to be limited in terms of the particular embodiments described in this application. Many modifications and variations can be made without departing from its spirit and scope, as will be apparent to those skilled in the art. Functionally equivalent methods, compositions and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by tie terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

Where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is;

1. A method of self-assembling polymers, comprising: attaching one or more biological binders to one or more multi-sectioned polymers, under conditions where a first biological binder attached to a first multi-sectioned polymer binds to a second biological binder attached to a second multi-sectioned polymer partner, thereby achieving self-assembly of the polymers.

2. The method of claim 1, wherein the biological binder is a macromolecule that hybridizes to a complementary macromolecule or that performs protein-protein interaction with a complementary macromolecule.

3. The method of claim 1, wherein the first and second multi-sectioned polymers are formed by a method comprising:
forming a laminar flow in a microfluidic system comprising a plurality of microfluidic channels,
wherein at least one channel comprises a solution comprising one or more oligomers,
so that a plurality of sections can be formed between the oligomer solutions; and polymerizing the plurality of the oligomer solutions to form the first and second multi-sectioned polymers,
thereby forming the first and second multi-sectioned polymers.

4. The method of claim 3, wherein the plurality of oligomers are polymerized by illuminating a light source.

5. The method of claim 4, wherein the light source comprises ultraviolet light.

6. The method of claim 3, wherein the method of forming the first and second multi-sectioned polymers further comprises: controlling compositions of the plurality of oligomer solutions provided to the plurality of microfluidic channels to achieve a desired multi-section configuration of each of the first and second multi-sectioned polymers.

7. The method of claim 6, wherein controlling compositions of the plurality of oligomer solutions comprises controlling the compositions of the oligomer solutions such that at least one first oligomer solution is different from at least one second oligomer solution.

8. The method of claim 3, wherein attaching one or more biological binders to each of the multi-sectioned polymers comprises: contacting the one or more biological binders to at least one chemically-treated nanoparticle, wherein the one or more biological binders are contained in a solution in a microfluidic channel, and the chemically-treated nanoparticle combines the one or more biological binders to the one or more multi-sectioned polymers, under conditions such that the one or more nanoparticle contacted biological binders are attached to at least one section of each of the first and second multi-sectioned polymers.

9. The method of claim 8, wherein the nanoparticles are chemically treated with a chemical compound comprising thiol function group.

10. The method of claim 1, wherein the biological binders are selected from the group consisting of: DNA, RNA, PNA, artificial nucleic acids, artificial polypeptides and protein.

11. The method of claim 1, wherein two or more biological binders are attached individually to two or more sections of one or more multi-sectioned polymers.

12. The method of claim 11, further comprising repeating assembling of the polymers to form a web structure of self-assembled polymers.

13. A self-assembled polymer structure formed using the method of claim 1.

14. A biosensor comprising one or more self-assembled polymer structures formed using the method of claim 1.

15. A self-assembled polymer structure comprising:
a plurality of multi-sectioned polymers; and
one or more biological binders attached to each of the multi-sectioned polymers, wherein each binder can bind to a complementary partner biological binder,
wherein the multi-sectioned polymers are assembled using the complementary sequences of the one or more biological binders attached to each of the polymers.

16. The self-assembled structure of claim 15, wherein the one or more biological binders are attached to at least one section of each of the multi-sectioned polymers.

17. The self-assembled structure of claim 15, wherein each of the multi-sectioned polymers is chemically treated.

18. The self-assembled structure of claim 17, wherein the polymers are chemically treated with a composition comprising a thiol function group.

19. The self-assembled structure of claim 15, wherein the biological binders are selected from the group consisting of: DNA, RNA, PNA, artificial nucleic acids, artificial polypeptides and protein.
